(19) United States
(12) Patent Application Publication
(10) Pub. No.: US 2026/0254347 A1
(43) Pub. Date: Aug. 27, 2026

(54) DC BUS ACTIVE DISCHARGE

(71) Applicant: Eaton Intelligent Power Limited, Dublin 4 (IE)

(72) Inventors: Vijay Shamrao MASKE, Kolhapur (IN); Sachin SHENOY KONCHADY, Mangalore (IN); Nilesh Kailasrao SURASE, Pune (IN)

(21) Appl. No.: 18/877,146

(22) PCT Filed: Jun. 30, 2023
(86) PCT No.: PCT/EP2023/025304

§ 371 Date: Dec. 19, 2024

(30) Foreign Application Priority Data
Jun. 30, 2022 (IN) 202211037624

(51) Int. Cl. H02M 1/32; H02M 1/088; H02M 7/483; H02M 7/5395

(52) U.S. Cl. CPC H02M 1/322; H02M 1/088; H02M 7/483; H02M 7/5395

(57) ABSTRACT

An active discharge system and method includes an inverter circuit including a plurality of inverter legs including a first inverter leg and a second inverter leg, with each leg including first and second power switches. In response to a first active discharge event, the first and second power switches of the first inverter leg are operated to discharge a high voltage bus connected to the inverter. In response to a subsequent, or second active discharge event, the first and second power switches of the second inverter leg are operated to discharge the high voltage bus connected to the inverter.

### BACKGROUND

In certain power circuits, especially high voltage DC (HVDC) power electronics systems such as those used in automotive applications, various high voltage energy storage elements (HVESEs) are used on a direct current (DC) link. Such HVESEs may include a high voltage battery and a high voltage DC bus capacitor. Components such as the DC bus capacitor are discharged after shutdown of the associated inverter system for various reasons, such as passenger safety, emergency systems, etc.

Active discharge is used in a variety of circumstances, including internal fault reaction, HVDC over voltage, HVDC voltage sensor issues, loss of low voltage power, shutdown events, and the like.

### SUMMARY

In accordance with some aspects of the present disclosure, an active discharge method includes providing an inverter circuit including a plurality of inverter legs including a first inverter leg and a second inverter leg, with each leg including first and second power switches. In response to a first active discharge event, the first and second power switches of the first inverter leg are operated to discharge a high voltage bus connected to the inverter. In response to a subsequent, or second active discharge event, the first and second power switches of the second inverter leg are operated to discharge the high voltage bus connected to the inverter.

In accordance with further aspects of the disclosure, a high voltage DC active discharge system includes a DC power source connected between first and second power rails, and a DC bus capacitor connected between the first and second power rails. An inverter circuit has a first inverter leg, a second inverter leg and a third inverter leg. Each of the first, second and third inverter legs includes first and second power switches connected in series between the first and second power rails. A controller is configured to selectively operate the first and second power switches of the first, second and third inverter legs to energize windings of a motor. The controller is further configured to operate the first and second power switches of a selected one of the first, second or third inverter legs in response to a first active discharge event to discharge the DC bus capacitor.

In accordance with still further aspects of the disclosure, an inverter circuit includes a first inverter leg including first and second power switches connected in series between first and second power rails, a second inverter leg including first and second power switches connected in series between the first and second power rails, and a third inverter leg including first and second power switches connected in series between the first and second power rails. A controller is configured to selectively operate the first and second power switches of the first, second and third inverter legs to energize windings of a motor. The controller is further configured to select one of the first, second or third inverter legs based on a predetermined parameter, and operate the first and second switches of the selected inverter leg to actively discharge a DC bus capacitor connected between the first and second power rails response to a first active discharge event.

### BRIEF DESCRIPTION OF THE DRAWINGS

FIGS. 1A and 1B are circuit diagrams illustrating an example of an active discharge system in accordance with aspects of the present disclosure.

FIG. 2 is a block diagram illustrating further aspects of the active discharge system shown in FIGS. 1A and 1B.

FIG. 3 illustrates portions of example control signals for gate drivers to implement the active discharge process in the system shown in FIGS. 2 and 3.

FIG. 4 illustrates further aspects of the control signals illustrated in FIG. 3.

FIG. 5 is a flow diagram illustrating aspects of an active discharge method in accordance with the present disclosure.

FIG. 6 is a flow diagram illustrating aspects of another active discharge method in accordance with the present disclosure.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as top, bottom, front, back, etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense.

High voltage DC (HVDC) power electronics systems such as those used in automotive applications, include various high voltage energy storage elements that are used on a direct current (DC) link. Components of such systems are discharged after shutdown of the associated inverter system for various reasons, such as passenger safety, emergency systems, etc. Active discharge is used in a variety of circumstances, including internal fault reaction, HVDC over voltage, HVDC voltage sensor issues, loss of low voltage power, shutdown events, and the like.

Some traditional HVDC discharge systems include dedicated discharge circuitry that is used to dissipate and/or otherwise discharge a stored charge in the system, which can add to cost and complexity of the system. In accordance with aspects of the present disclosure, the same circuit is used in a normal operating mode and also in a discharge mode to provide safe discharge of stored energy while eliminating the need for dedicated discharge circuitry.

For example, a three-phase inverter circuit can be used in a high voltage power electronics system to dissipate energy stored in a high voltage DC bus capacitor through components of the inverter, in addition to the inverter's normal operation of energizing motor windings.

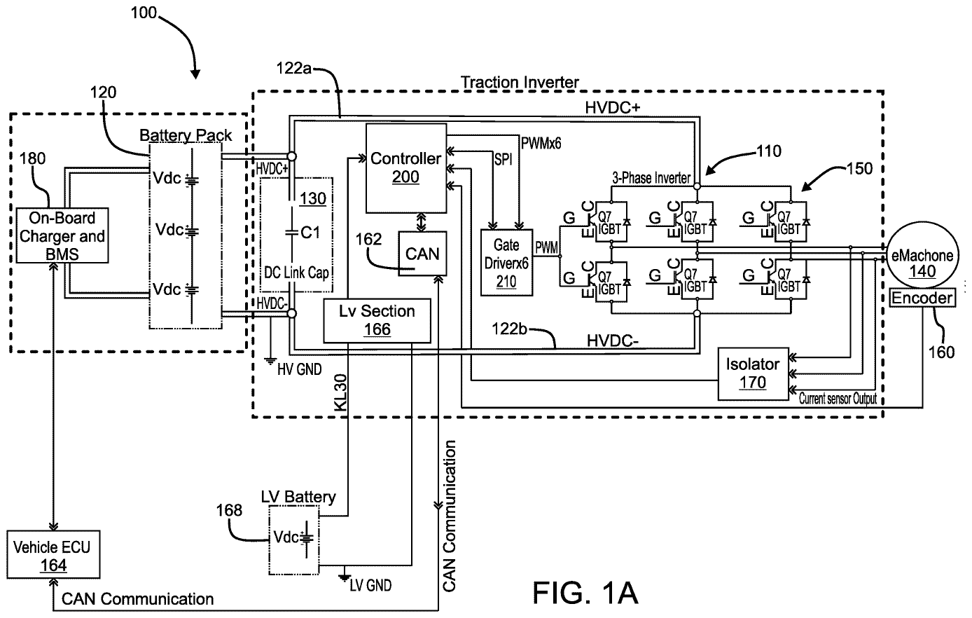

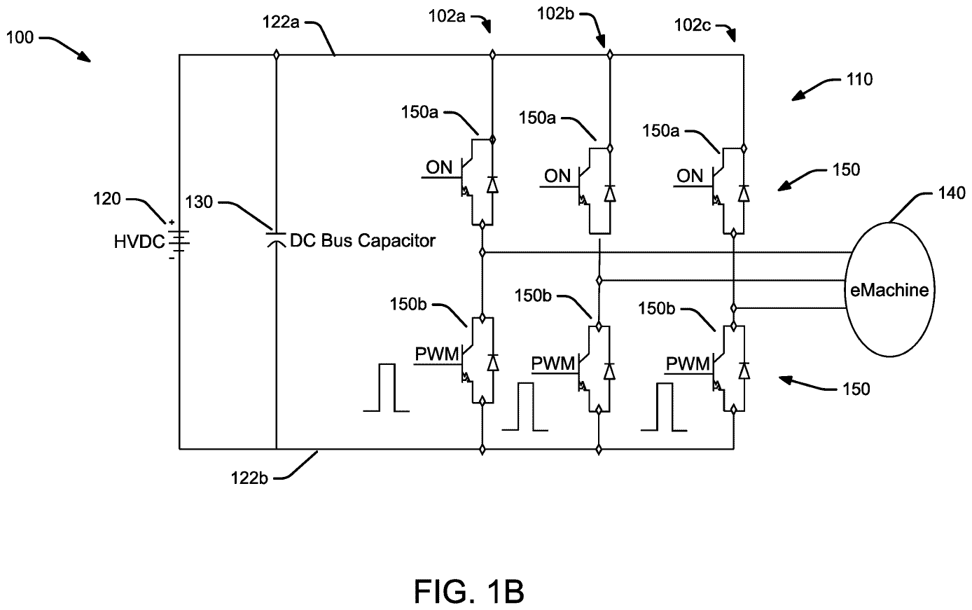

FIG. 1A illustrates an example of a high voltage power electronics system 100 in accordance with the present disclosure. The system 100 includes an inverter 110. The example system 100 can be used for motor control to provide power and control to one or more electric motors and support one or more powertrain topologies, for example. The circuit 100 can transfer energy stored in a high voltage battery system 120 into instantaneous, multiphase, alternating current (AC) power for a traction drive, etc.

The example of FIG. 1A further includes a high-voltage battery 120 and a high voltage bus capacitor 130 connected between upper and lower power rails 122a and 122b. A charger and battery management system (BMS) 180 is connected to the battery system 120. The inverter 110 is configured to convert DC power from the battery 120 into AC power to generate a rotating magnetic field for an electric machine such as a motor 140, for example. In some examples, the motor 140 may further function as a generator. In certain examples, motor speed, phase voltages, and phase currents are sensed in order to realize closed loop controls of the motor variables such as speed and torque. An encoder 160 may provide motor position information to a controller 200, and phase current information may be output to an isolator 170, which sends phase current information to the controller 200. Based thereon, operation of power switches are controlled to achieve the desired operation of the motor 140.

FIG. 1B illustrates further aspects of the system 100. The inverter 110 includes three branches or legs 102a, 102b and 102c (collectively inverter legs 102), each of which has two power switches 150a, 150b (collectively power switches 150) connected in series between the upper and lower power rails 102a, 102b. The switches may include, for example, bipolar transistors, IGBTs, MOSFETs, SiC, etc. To control the current and voltage applied to the motor 140, a motor controller generates PWM signals that are applied to gate terminals of the switches 150 such that the switches 150 in the motor's bridge are PWM controlled to provide the desired motor voltage and current.

The controller 200 is connected to a vehicle controller area network (CAN) bus 162 to communicate with a vehicle electronic control unit (ECU) 164. The controller 200 is further connected to a low voltage section 166, which is connected to a low voltage batter 168.

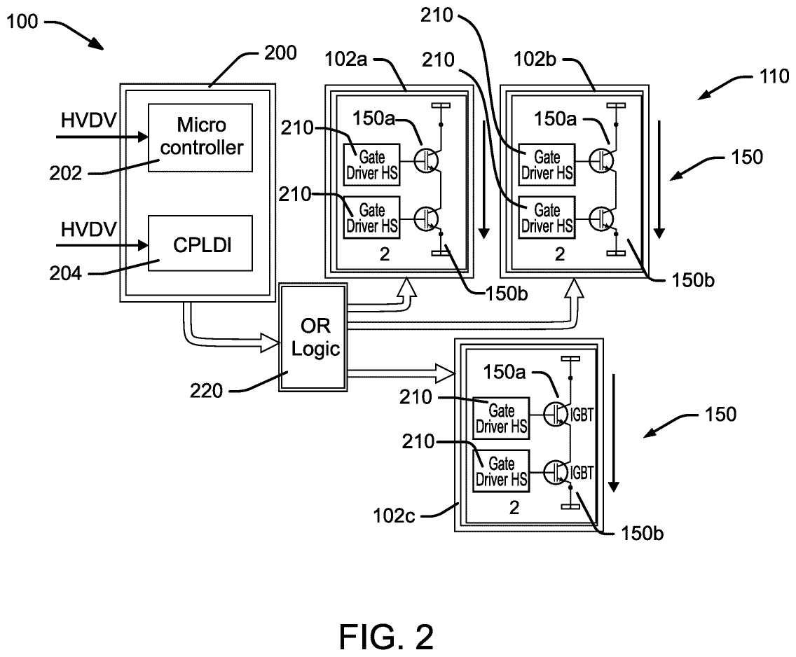

FIG. 2 is a block diagram illustrating further aspects of the system 100. As noted above, a motor controller 200, which may include a microcontroller 202 and/or a programmable device 204, is configured to control gate drivers 210 connected to the gate terminals of respective power switches 150. The gate drivers 210 are configured to provide input signals to a gate terminal of a corresponding power switch 150 to switch the respective power switch on or off. The controller 200 is connected to a logic circuit 220 configured to apply the control signals to the gate drivers 210 of the desired or selected leg 150a, 150b, 150c of the inverter 110. In some embodiments, the controller 200 controls the gate drivers 210 to operate in an “on” mode (i.e. control the corresponding switch so it is maintained in an on, or conducting state), an “off” mode (i.e. control the corresponding switch so it is maintained in an off, or nonconducting state), or a pulse width modulation (PWM) mode in which a PWM signal is applied to the gate terminal of the corresponding power switch 150.

Referring to the example of FIGS. 1 and 2, the first and second power switches 150a, 150b (also referred to herein as an upper power switch 150a and lower power switch 150b) are IGBTs with a respective parallel connected diode. A node between the upper switch 150a and lower switch 150b of each leg 102a, 102b and 102c is connected to a rotating machine, such as a three-phase motor-generator 140.

The power switches 150 are operated by control signals from the motor controller 200 to convert DC power supplied from the battery 120 into three phase AC power. This power that has been converted is supplied, for example, to armature windings of the motor 140. The inverter circuit 110 is thus configured as a three phase bridge circuit in which the series-connected upper and lower power switches 150a, 150b of each leg 102a, 102b, 102c are connected in parallel between the upper and lower power rails 122a, 122b. The capacitor 130 suppresses fluctuations of the DC voltage generated by the switching operation of the power switches 150.

When configured to operate the motor 140, the motor controller 200 provides control signals based on various variables such as desired torque, speed, etc. PWM signals is output to the gate drivers 210 to control the power switches 150 to apply the desired wave forms to the windings of the motor 140.

In a regenerative operation, motor 140 is used as a generator. The power switches are controlled in a predetermined fashion such that the current generated in motor windings by rotation of the rotor of the motor 140 may be used to charge the battery 120, for example.

In some examples, the power switches (i.e. IGBTs) 150 are additionally used for active discharge of the capacitor 130, such that an additional active discharge circuit is not required. This can result in a reduced PCB size and component count optimization.

The controller provides gate driver signals to gate terminals of the power switches 150 to perform active discharge of the capacitor 130. The power switches 150, gate drivers 210 and controller 200 together synchronize the operation for each half bridge of the inverter 110 to perform the active discharge and ensure the DC bus capacitor 130 is discharged as desired.

The gate voltages of power switches 150 are controlled to limit the current flowing through the inverter legs 102 in event of an active discharge event. By controlling the gate voltages, the power switches 150 are operated in a “safe” operating area of the components to avoid failures and thermal runaway events. For instance, the DC bus discharge may be determined according to various factors such as operating frequency, on-time for the power switches 150, associated gate voltage levels, etc. To have full energy discharge for the inverter 110, the number of PWM pulses to be excited in given span of duration as dictated by the switch manufacturer, for example. During the active shutdown process, the power switches 150 may be heated due to the discharge current flowing therethrough. As discussed further below, temperature of the component, among other things, may be monitored to operate the components within desired parameters.

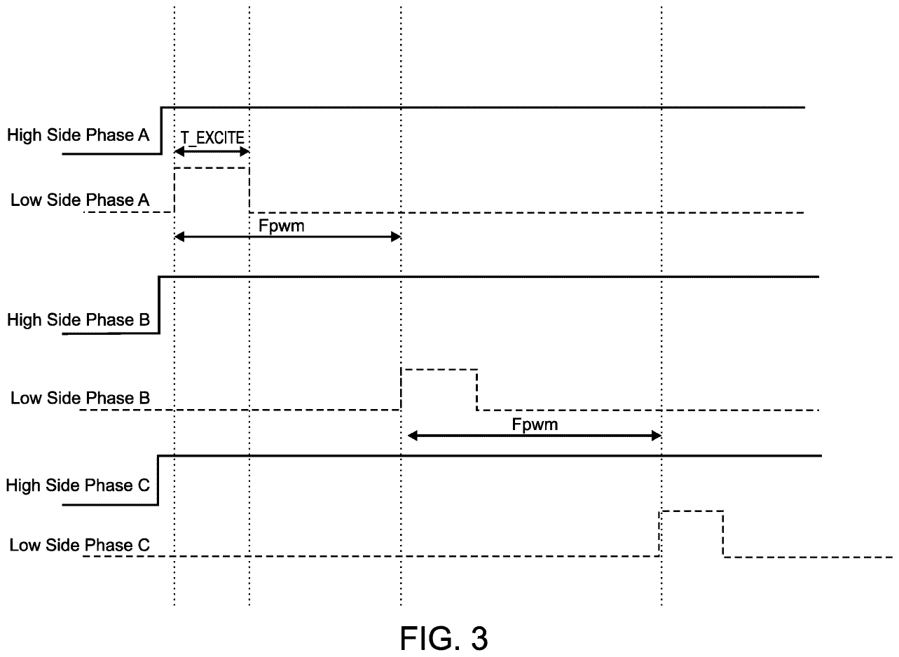

FIG. 3 illustrates portions of control signals for gate drivers 210 to implement the active discharge process. For a controlled current “shoot through,” desired leg(s) 102 of the inverter 110 are used. The logic circuit 220 may be configured to output control signals from the controller 200 to the desired leg 102 of the inverter 110. One of the power switches 150 (e.g. the high side switch 150a) of a given inverter leg is held ON by the respective gate driver 210, while the opposite power switch is controlled (i.e. ON/OFF) according to a PWM signal Fpwm generated by “safe logic” by the controller 200 and/or gate driver 210. The controlled shoot through method provides a safe active discharge operation by applying a closed loop strategy on the PWM signal duration and eventually the applied gate voltage. The PWM signal generated is clamped to a time duration T_EXCITE that can be programmed into the controller 200. Alternatively, the controlled shoot through can also be performed by keeping the low side switch 150b ON while providing the PWM signal to the high side switch 150a.

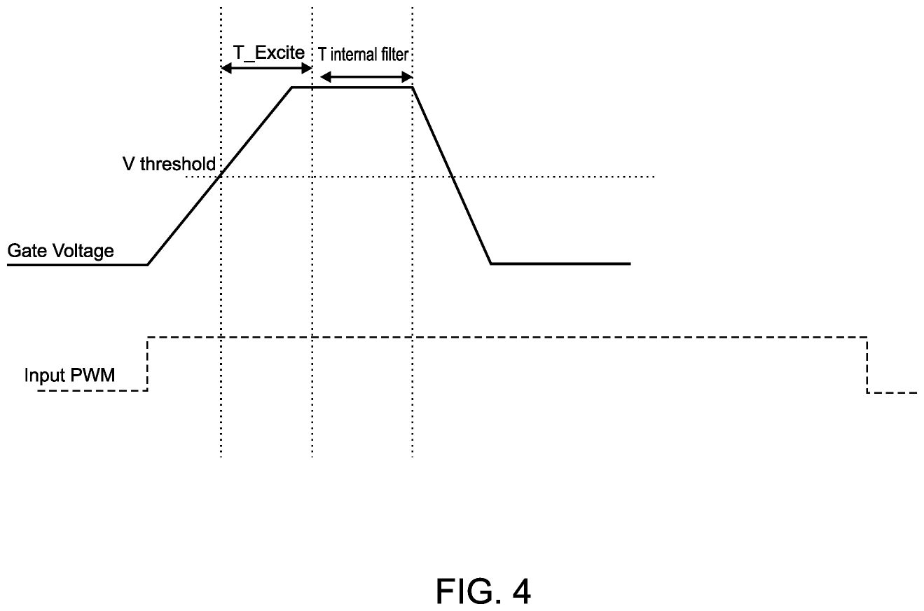

FIG. 4 illustrates further aspects of the active discharge logic. When the PWM positive edge is applied to the gate terminal of the desired power switch 150, the switch output VO begins to charge and the resultant gate to source voltage begins to rise. The active discharge control technique is based on the power switch threshold voltage V_threshold and the programmable T_EXCITE time (e.g. 0 ns to 70 ns). The gate drivers 210 are configured to continuously monitor the gate to source (or gate to emitter depending on the type of power switches 150 applied) voltage. When the gate to source voltage is greater than the threshold voltage V_threshold, an internal timer starts, and after the programmed T_EXCITE duration is reached, the date driver 210 turns off the gate voltage.

In some examples, the gate drivers 210 each include an internal comparator configured to determine the T_EXCITE duration. The internal comparator is further configured with a fixed time delay T_internal filter to increase the overall ON time, allowing reduction of the T_EXCITE time, and in turn reducing the overall ON time of the external FET. Having control of the threshold voltage V_Threshold and T_EXCITE, the shoot through current can be controlled.

As noted above, active discharge of the HVDC bus and the associated bus capacitor 130 is often desired in applications such as automotive and power electronics units in general. After “normal” operation of the inverter 110 (i.e. converting DC power from the battery 120 to AC power for the motor 140), shutdown of the inverter may be required. Some applications further use an active shut down, such as for system faults, HVDC over voltage conditions, HVDC voltage sensor failures, loss of LV power, and safe shutdown events (e.g. ignition off condition). Rather than employ a separate, dedicated discharge circuit including components such as a high-voltage resistor array, disclosed examples use components of the inverter 110 for active shutdown and discharge of the HVDC bus including the DC bus capacitor 130.

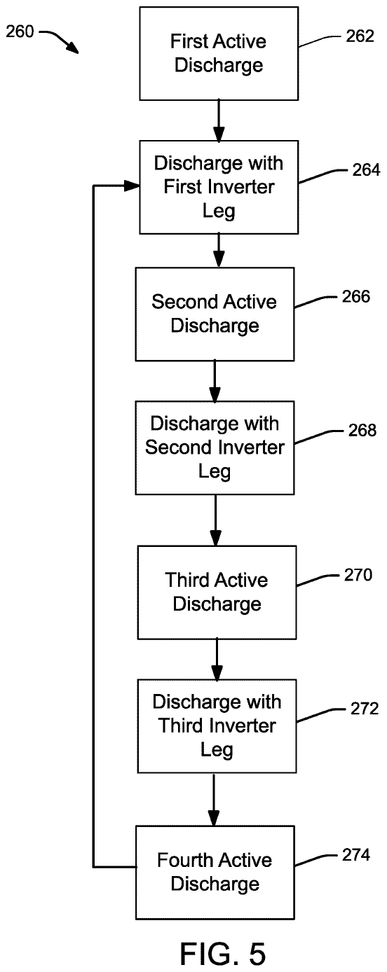

Some examples avoid thermal runaway by executing a polling method for each half bridge of the inverter 110 for each active discharge event. Further, the particular inverter branch 102 used for the active discharge may be “rotated” from one branch to the next to address continued heat rise of the inverter branches, thus avoiding reliability issues for the inverter components. Such “rotation” of the inverter branches 102 may be reflected in a method 260 shown in FIG. 5, where in response to a first active discharge event (i.e., system fault, ignition off, etc.) at an operation 262, the power switches 150 of the first inverter leg 102a are controlled to discharge the capacitor 130 at operation 264. In response to a second active discharge event in operation 266, the power switches 150 of the second inverter leg 102b are controlled to discharge the capacitor 130 at operation 268. In other words, a different inverter leg 102 is successively used for each active discharge operation. Thus, in response to a third active discharge event shown at operation 270, the third inverter leg 102c would be used for active discharge of the capacitor 130 in operation 272. Still further, in response to a fourth active discharge event in operation 274, the first inverter leg 102a would again be used for active discharge of the capacitor 130 in operation 264.

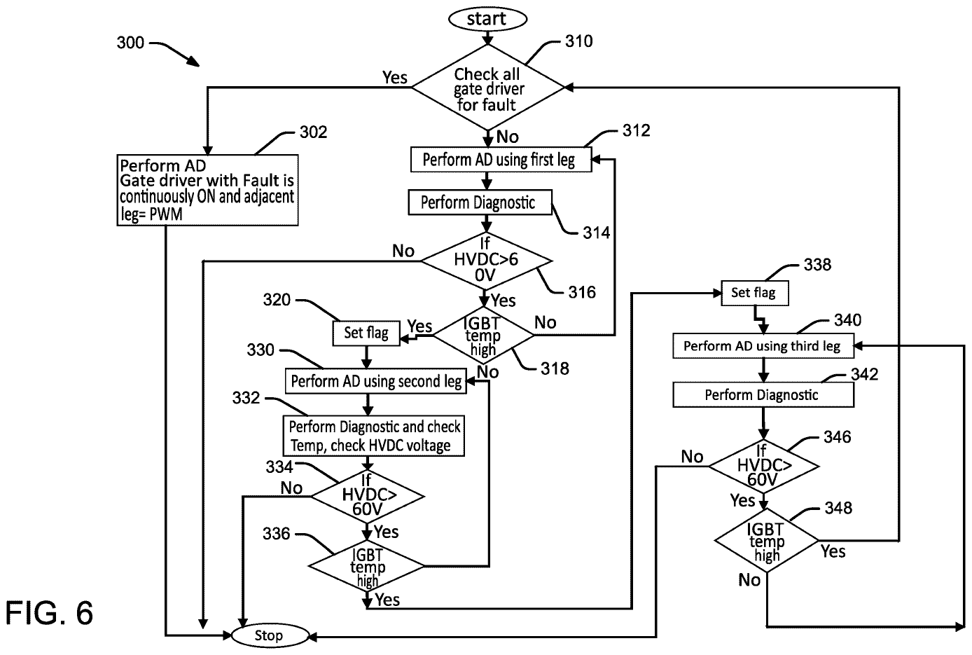

FIG. 6 is a flowchart illustrating an example of a polling method 300 for active discharge operations. At operation 310, the gate driver components (e.g. gate drivers 210 and power switches 150) for each inverter leg are checked for faults at operation 310. If a fault is found in a component of one or more of the inverter legs 102 at operation 310, active discharge is conducted by operating the gate drivers 210 and switches 150 of the “next” or adjacent inverter leg together with the inverter leg having the component fault. For example, if a gate driver fault for a gate driver 210 of the first leg 102a is determined at operation 310, at operation 302 an active discharge is performed in which the gate drivers 210 of the first leg 102a control the corresponding switches 150 in the on mode (i.e. the switches 150 are maintained in an on state), and the gate drivers 210 of the second leg 102b (i.e. the adjacent leg) operate one or both of the respective switches 150 in the PWM mode.

If no faults are determined at operation 310, active discharge is conducted using the first inverter leg 102a at operation 312. During the active discharge process, diagnostic tests are performed in operation 314. For example, in operation 316, high voltage DC level of the inverter bridge leg is determined and compared to a predetermined voltage level. If the HVDC level is less than the predetermined level (e.g. 60V) at operation 316, the active discharge operation is completed.

If the HVDC level determined at operation 316 is greater than the predetermined level, the temperature of the associated power switch 150 is compared to a predetermined temperature level (e.g. 175 degrees C.) at operation 318. If the temperature level does not exceed the predetermined temperature level, the active discharge process continues in the first branch 102a of the inverter 110 at operation 312.

If the temperature of the power switch 150 exceeds the predetermined temperature as determined at operation 318, an error flag is set at operation 320, and the active discharge operation is performed using the second leg 102b of the inverter 110 at operation 330. Diagnostic checks for the second inverter branch are performed at operation 332. If the HVDC voltage level is determined to not exceed the predetermined level at operation 334, the active discharge operation is completed using the second branch 102b of the inverter 110.

If the HVDC level determined at operation 334 is greater than the predetermined level, the temperature of the associated power switch 150 of the second branch of the inverter 110 is compared to a predetermined temperature level at operation 336. If the temperature level does not exceed the predetermined temperature level, the active discharge process continues in the second branch of the inverter 110 at operation 330.

If the temperature of the power switch 150 exceeds the predetermined temperature as determined at operation 336, an error flag is set at operation 338, and the active discharge operation is performed using the third leg 102c of the inverter 110 at operation 340. Diagnostic checks for the third inverter branch 102c are performed at operation 342. If the HVDC voltage level is determined to not exceed the predetermined level at operation 346, the active discharge operation is completed on the third branch 102c of the inverter 110.

If the HVDC level determined at operation 346 is greater than the predetermined level, the temperature of the associated power switch 150 of the third branch 102c of the inverter 110 is compared to a predetermined temperature level at operation 348. If the temperature level does not exceed the predetermined temperature level, the active discharge process continues in the third branch 102c of the inverter 110 at operation 340. If at operation 348 is determined that the temperature exceeds the predetermined level, the process returns to operation 310 where the gate drivers 210 are again checked for faults.

The foregoing outlines features of example embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An active discharge method, comprising:
providing an inverter circuit including a plurality of inverter legs including a first inverter leg and a second inverter leg, each leg including first and second power switches;
in response to a first active discharge event, operating the first and second power switches of the first inverter leg to discharge a high voltage bus connected to the inverter; and
in response to a second active discharge event, operating the first and second power switches of the second inverter leg to discharge the high voltage bus connected to the inverter.

2. The method of claim 1, wherein the plurality of inverter legs further includes a third inverter leg, the method further comprising:
in response to a third active discharge event, operating the first and second power switches of the third inverter leg to discharge the high voltage bus connected to the inverter.

3. The method of claim 2, further comprising:
in response to a fourth active discharge event, operating the first and second power switches of the first inverter leg to discharge the high voltage bus connected to the inverter.

4. The method of claim 1, wherein discharging the high voltage bus connected to the inverter includes discharging a high voltage DC bus capacitor connected to the inverter.

5. The method of claim 1, wherein operating the first and second power switches of the first inverter leg includes maintaining the first power switch on while applying a pulse width modulated (PWM) signal to the second power switch of the first inverter leg.

6. The method of claim 5, wherein the PWM signal is determined based on a gate to source voltage of the first one of the power switches.

7. The method of claim 1, wherein the first active discharge event includes an internal fault.

8. The method of claim 1, wherein the first active discharge event includes an ignition off condition.

9. The method of claim 1, wherein each inverter leg includes first and second gate drivers connected to the respective first and second power switches, the method further comprising:
in response to determining a fault in at least one of the first and/or second gate drivers of the first one of the inverter legs, maintaining the first and second power switches of the first inverter leg on while applying a pulse width modulated (PWM) signal to at least one of the first and/or second power switches of the second inverter leg to discharge the high voltage bus.

10. The method of claim 1, wherein operating the first and second power switches of the first inverter leg to discharge the high voltage bus connected to the inverter includes comparing a voltage level of the high voltage bus to a predetermined voltage level.

11. The method of claim 1, wherein operating the first and second power switches of the first inverter leg to discharge the high voltage bus connected to the inverter includes comparing a temperature of at least one of the first and or second switches to a predetermined temperature.

12. A high voltage DC active discharge system, comprising:
a DC power source connected between first and second power rails;
a DC bus capacitor connected between the first and second power rails;
an inverter circuit including a first inverter leg, a second inverter leg and a third inverter leg, each of the first, second and third inverter legs including first and second power switches connected in series between the first and second power rails;
a controller configured to selectively operate the first and second power switches of the first, second and third inverter legs to energize windings of a motor; and
wherein the controller is further configured to operate the first and second power switches of a selected one of the first, second or third inverter legs in response to a first active discharge event to discharge the DC bus capacitor.

13. The system of claim 12, wherein the inverter circuit further includes plurality of gate drivers, each of the first and second switches of the first, second and third inverter legs having a corresponding gate driver connected thereto.

14. The system of claim 13, wherein gate drivers are configured to selectively operate their respective first and second switches in an on mode, an off mode, and a PWM mode.

15. The system of claim 14, wherein gate drivers are configured to selectively the first switch of the first inverter leg in the on mode and the second switch of the first inverter leg in the PWM mode to actively discharge the DC bus capacitor in response to response to the first active discharge event.

16. The system of claim 15, wherein gate drivers are configured to selectively the first switch of the second inverter leg in the on mode and the second switch of the second inverter leg in the PWM mode to actively discharge the DC bus capacitor in response to response to a second active discharge event.

17. The system of claim 15, wherein gate drivers are configured to clamp a PWM signal based on a threshold voltage of the first and second power switches.

18. An inverter circuit, comprising:
a first inverter leg including first and second power switches connected in series between first and second power rails;
a second inverter leg including first and second power switches connected in series between the first and second power rails;
a third inverter leg including first and second power switches connected in series between the first and second power rails;
a controller configured to selectively operate the first and second power switches of the first, second and third inverter legs to energize windings of a motor; and
wherein the controller is further configured to select one of the first, second or third inverter legs based on a predetermined parameter, and operate the first and second switches of the selected inverter leg to actively discharge a DC bus capacitor connected between the first and second power rails response to a first active discharge event.

19. The inverter circuit of claim 18, wherein the predetermined parameter includes a voltage level of the selected inverter leg.

20. The inverter circuit of claim 18, wherein the predetermined parameter includes a temperature of the first and second power switches of the selected inverter leg.
